(19) United States
(12) Patent Application Publication
(10) Pub. No.: US 2015/0060531 A1
(43) Pub. Date: Mar. 5, 2015

(54) High Capacity Pocket File Folder

(71) Applicant: Smead Manufacturing Company, Hastings, MN (US)

(72) Inventor: Michael D. Leonard, Woodbury, MN (US)

(21) Appl. No.: 14/536,861

(22) Filed: Nov. 10, 2014

Related U.S. Application Data
(63) Continuation of application No. 13/484,717, filed on May 31, 2012.

(51) Int. Cl. B42F 7/06; B31B 1/20

(52) U.S. Cl. CPC B42F 7/06; B31B 1/20
USPC 229/67.1; 493/228

(57) ABSTRACT

A pocket folder with increased document capacity and method of manufacturing same is disclosed. The folder has two cover panels 14-16, joined along a longitudinal joint or score line, a pair of pocket flaps 40a-40b and a top flap 70. Top flap 70 folds along a score line 72a-72b and a midline score 74 and a plurality of parallel scores 78 to accommodate expansion. At the pockets, a v-shaped notch 52 between the pockets prevents bunching and a circular cut away 90a-90b provides greater access to the documents.

### CROSS-REFERENCE TO RELATED APPLICATION

Not Applicable

### BACKGROUND

1. Field of the Disclosure

The present disclosure invention is directed to file folders and more particularly to pocket style file folders with the ability to handle a large number of documents.

2. Description of the Related Art

Pocket folders are typically characterized by having two leaves or side panels, joined longitudinally on a fold line and one or more of the panels having a pocket. One of the first examples of such a product is found in U.S. Pat. No. 304 845 to Moss (1884). A later embodiment is found in U.S. Design No. Des. 312 275 to Wyant (1990). A further example is US Publication No. US2004/0066031 to Wong (2004).

Typically such pocket folders suffer from one of two problems (or both): 1) when the pockets are filled with too many sheets, they bulge and don't fold properly, thereby damaging the folder and often the papers and 2) if some accommodation has been made to problem 1 above, then the papers in the pockets may fall out easily because the accommodation disturbs the viability of the pocket feature.

The present disclosure addresses both of these problems with an innovative solution.

### BRIEF SUMMARY OF THE INVENTION

The following summary is intended to assist the reader in understanding the full disclosure and the claims. The claims define the scope of the invention, not this summary.

The disclosure includes a document holder having a first cover and a second cover, having upper, bottom, inner and outer peripheral edges joined together along their inner edges at a joint and defining a joint axis; each of said first cover and said second cover, each having an interior surface on the interior of the document holder and an outer surface on the exterior of the document holder; a pair of pockets formed of a pocket face attached to each of the covers at the bottom and outer edges and substantially unattached at its inner edge, said pocket face inner edge including a an angular shaped notch extending upwardly from its bottom edge at its inner edge and running upwardly, such as at a slight diagonal from the bottom edge joint axis intersection toward the upper edge away from the axis, the angular shaped notch of each pocket face together forming a v-shaped notch between the two, thereby creating a v-shaped gap.

The disclosure also includes a further retainer flap foldably attached at the upper edge of each cover, said flap spanning said covers but not being connected at the joint and, when in its unfolded state, forming an aperture bounded by the flap and the upper edges of the covers, said flap having a central fold line co-axially aligned with said joint axis and further including a plurality of parallel scored fold lines on either central fold line.

The disclosure also includes a semi-circular or circular concave cut away edge extending from the upper edge of the angular shaped notch on each pocket face to the upper edge of the pocket face, the semi-circular edges of the pocket faces together forming a generally have circle cut out formed between the pocket faces, with a v-shaped central base at the semicircle.

The disclosure also includes a retainer flap which is formed as a semi-circular element having a semi circular inner and outer peripheral edges.

The disclosure also includes a method of forming a blank for folding into a pocket folder by creating and scoring a blank sheet with the following, using some or all of these steps in any order:

A. cutting and scoring a blank having left and right edges and left and right portions and upper and lower edges and a central longitudinal score forming a center line and a lateral score line orthogonal to the central longitudinal score line located at a predetermined distance from the bottom of the blank;

B. cutting away a portion of the blank at its top edge orthogonal to the central score line, a semicircular flap protrusion, and defining an upper longitudinal edge of the blank, excluding the protrusion;

C. scoring said blank along the upper edge to define a fold line between the protrusion and the upper edge;

D. removing material between the protrusion and the upper edge to define an aperture, said aperture being generally symmetrical along the said fold line;

E. scoring a protrusion fold line in said protrusion, said protrusion fold line being co-axial with said blank fold line;

F. cutting a v-shaped notch into the bottom from at the central score line to said predetermined distance from the bottom;

G. folding along the said blank along said lateral score line to form a pair of side by side pockets;

H. folding said protrusion along said protrusion fold line to create a top retaining tab;

I. cutting away a section of the blank on the left and right portions adjacent to the bottom of the blank and side scoring the blank on the left and right portions longitudinally spaced at a predetermined distance from the left and right edges;

J. folding said blank along said at said side scoring;

K. affixing said side scoring portions to said pockets.

### BRIEF DESCRIPTION OF THE SEVERAL VIEWS OF THE DRAWINGS

FIG. 1 illustrates a top plan view of a blank according to one embodiment.

FIG. 2 illustrates a top plan view of a blank according to a second embodiment.

FIG. 3 illustrates a front perspective view of a pocket folder according to the first embodiment.

FIG. 4 illustrates a front plan view of FIG. 3.

FIG. 5 illustrates a rear plan view of FIG. 3.

FIG. 6 illustrates a top plan view of FIG. 3.

FIG. 7 illustrates a bottom plan view of FIG. 4.

### DETAILED DESCRIPTION OF THE DISCLOSURE

The present description shows pocket folder 10. It should be understood that the term pocket holder includes any form of document holder which has at least two faces, each having a pocket which are joined together by a central longitudinal fold line or joint.

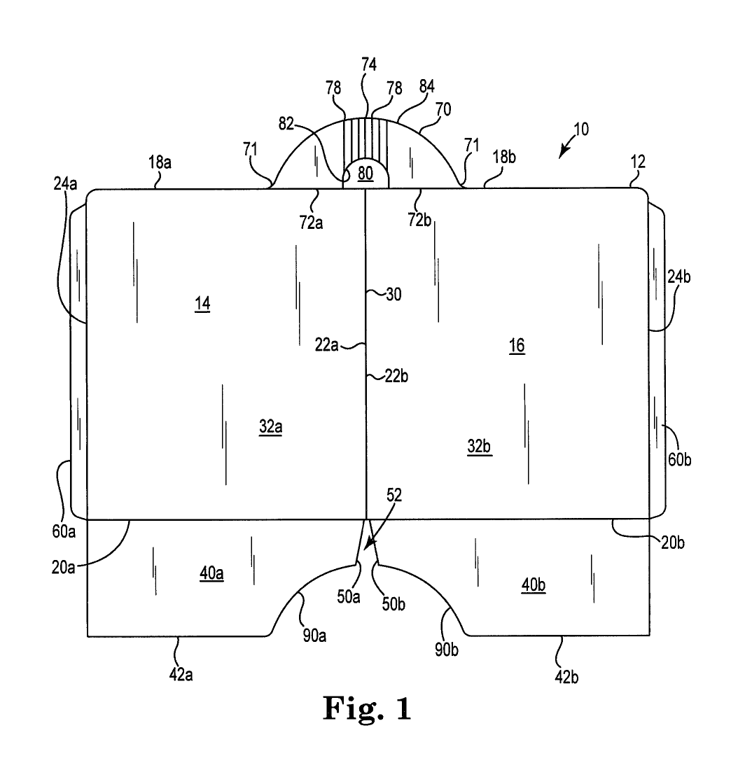

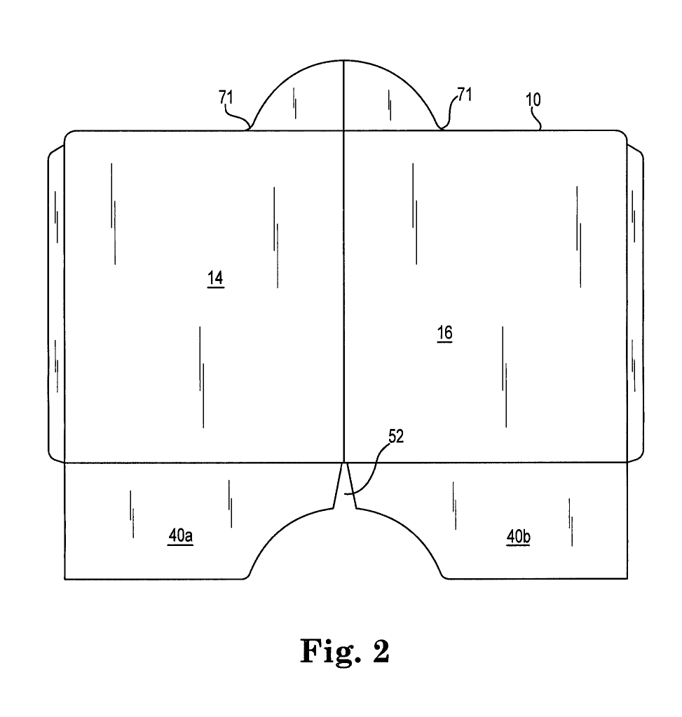

In the embodiment shown in FIG. 1 folder 10 is preferably made of single blank of materials, often a double or triple weight board material or synthetic such as plastic. In the method as described below, various cuts and folds are made in the blank to achieve the desired features.

The blank 12 is shown after cutting portions away as shown in FIG. 1. The blank includes a first cover 16 and a second cover 16 each having upper (18a-18b), bottom (20a-20b), inner (22a-22b) and outer (24a-24b) peripheral edges joined together along their inner edges at a joint 30 and defining a joint axis; each of said first cover and said second cover, each having an interior surface 32a-32b on the interior of the document holder and an outer surface 34a-34b on the exterior of the document holder (FIG. 5); a pair of pocket flaps 40a-40b formed of a pocket face attached to each of the covers at the bottom 20a-20b and outer edges 42a-42b and substantially unattached at what becomes upper edge 42a-42b after folding.

The pocket flaps 40a-40b have a side edge 50a-50b which includes a v-shaped notch 50 which is formed by the cutting away of a portion of the flap 40a-40b at an angle away from the fold line 30. The cut away at 50a-50b is preferably sufficient to prevent buckling of the pockets as they are filled with documents. The cut away on each flap is preferably 5 degrees off center line 30 or as shown making the v-notch roughly 10 degrees. Other possible cuts of the center line are for example, 5-10 degrees, 7.5-10 degrees, 10-15 degrees, 15-30 degrees. The cut away can also be at a greater angle to accommodate more documents, up to approximately 45 degrees when it begins to interfere with the functioning of the pocket itself by the removal of so much material.

To accomplish the objectives of the notch 52 and yet provide access to the documents, a further cut away is possible, where a circular portion 90a-90b is cut away from each pocket flap. In the preferred embodiment the cut away is circular and starts from the upper edge of the v-notch and extends into the flap toward its edge 42a-42b. The cut may also be a diagonal straight line from the top of the v-notch to end.

Edges 42a-42b or so other shape to expose as much of the document as possible without losing the integrity of the pocket.

The pocket flaps are also folded along a score line 20a-20b at a predetermined distance from the edges 42a-42b and side flaps 60a-60b are folded and bonded to the flaps along the edge score 24a-24b. Score lines are defined as depressions impressed into the material which compresses the material/fibers so that they bend/fold on a predictable path. The side flaps are a predetermined width extending from the edge 24a-24b but in fact are formed by cutting of the blank.

To assist in holding documents in the pockets, a top flap 70 is formed at top score line 72a-72b which runs along the top edge 18a-18b. At the intersection of flap 70 with the top edge, the flap is slightly radiused, ie the flap “flows” into the top edge so that there is no corners to provide a tear point and undue stress on the fibers of the material. Likewise, score line 72a-72b must preferably pass entirely through the intersection between the top tab and the top surfaces so that the material fibers are less likely to tear. In fact, the score line compresses the fibers and gives them additional strength at a high stress point.

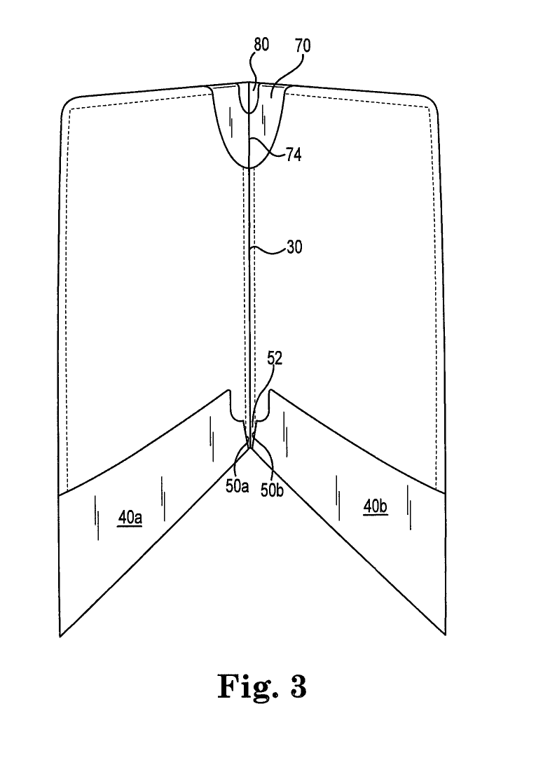

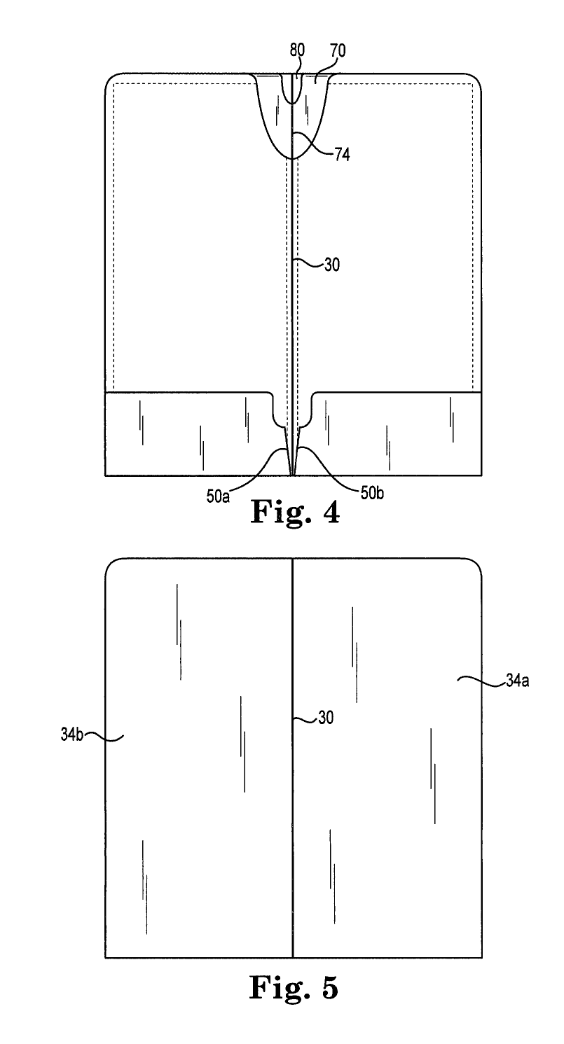

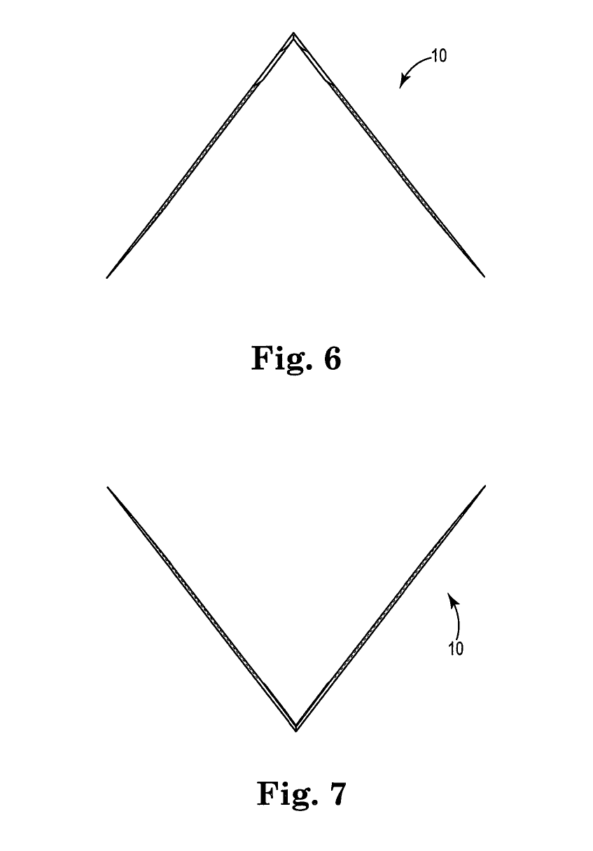

Flap 70 also includes a main score line 74 which is co-axial with fold line 30 so that when the folder is folded, the top flap also folds symmetrically along line 74. Flap 70 is folded over as shown in FIG. 3 when in use. To accommodate documents of varying thicknesses, top flap 70 preferably includes a plurality of parallel spaced apart score lines 78 which assist the flap in bending to accommodate additional thicknesses without buckling.

Likewise, in one embodiment, a portion of the top flap 70 is cut away to reveal an aperture 80 which is bounded on one edge by the top edges 18a-18b and on the semicircular inner edge 82 of the tab. The inner edge 82 may be other shapes besides circular, such as a v-cut or diamond shaped. The outer edge 84 of the top tab is also shown as circular but it too may be other shapes such a triangular, v-shaped, rectangular, etc.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1.-7. (canceled)

8. A document holder comprising:
a. a first cover and a second cover, each having top, bottom, inner and outer peripheral edges,
b. said inner peripheral edges being joined together defining a joint axis;
c. each of said first cover and said second cover having an interior surface and an exterior surface;
d. a pair of pockets formed of a pocket face having top, bottom and inner edges, said faces extending from the bottom of each of the covers and unattached at their top edges, said pocket face having an inner edge which when the face is folded, lies adjacent said joint axis and includes a diagonal shaped notch extending upwardly from its bottom edge,
e. the diagonal notch of each pocket face together forming a v-shaped notch between the two faces, thereby creating a v-shaped gap therebetween, said notch extending from said bottom of each of said pockets and away from said joint axis to create an increasing void from said bottom and
f. circular concave edge extending from the upper edge of the diagonal shaped notch on each pocket face to the upper edge of the pocket face, the concave edges of the pocket faces together forming a generally semi-circular cut away formed between the pocket faces, with a v-shaped central base of the semicircle:
g. a top retainer flap foldably attached at the upper edge of each cover, said flap spanning said covers but not being connected at the joint axis, and when in its unfolded state, forming an aperture bounded by the flap and the upper edges of the covers, said flap having a central fold line co-axially aligned with said joint axis.

9. The holder of claim 8, wherein the retainer flap further includes a plurality of spaced apart generally parallel vertical score lines on both sides of the central fold line.

10. The holder of claim 9, wherein said retainer flap defines an aperture extending from the top edges of the covers and the flap.

11. The holder of claim 10, wherein said retainer flap has an outer and inner semi-circular periphery.

12. A document holder comprising:
a. a first cover and a second cover, each having top, bottom, inner and outer peripheral edges,
b. said inner peripheral edges being joined together defining a joint axis;
c. each of said first cover and said second cover having an interior surface and an exterior surface;
d. a pair of pockets formed of a pocket face having top, bottom and inner edges, said faces extending from the bottom of each of the covers and unattached at their top edges, said pocket face having an inner edge which when the face is folded, lies adjacent said joint axis and includes a diagonal shaped notch extending upwardly from its bottom edge,
e. the diagonal notch of each pocket face together forming a v-shaped notch between the two faces, thereby creating a v-shaped gap therebetween, said notch extending from said bottom of each of said pockets and away from said joint axis to create an increasing void from said bottom and
f. a circular concave edge extending from the upper edge of the diagonal shaped notch on each pocket face to the upper edge of the pocket face, the concave edges of the pocket faces together forming a generally semi-circular cut away formed between the pocket faces, with a v-shaped central base of the semicircle.

13. A method of forming making a blank and for folding the blank into a pocket folder comprising the steps of:
a. cutting and scoring a blank having left and right edges and left and right portions and upper and lower edges and a central longitudinal score forming a center line and a lateral score line orthogonal to the central longitudinal score line located a predetermined distance from the bottom of the blank;
b. cutting away a portion of the blank at its top edge orthogonal to the central score line, a semicircular flap protrusion, and defining an upper longitudinal edge of the blank, excluding the protrusion;
c. scoring said blank along the upper edge to define a fold line between the protrusion and the upper edge;
d. removing material between the protrusion and the upper edge to define an aperture, said aperture being generally symmetrical along the said fold line;
e. scoring a protrusion fold line in said protrusion, said protrusion fold line being co-axial with said blank fold line;
f. cutting a v-shaped notch into the bottom from at the central score line to said predetermined distance from the bottom;
g. folding along the said blank along said lateral score line to form a pair of side by side pockets;
h. folding said protrusion along said protrusion fold line to create a top retaining tab;
i. cutting away a section of the blank on the left and right portions adjacent the bottom of the blank and side scoring the blank on the left and right portions longitudinally spaced a predetermined distance from the left and right edges;
j. folding said blank along said at said side scoring, and
k. affixing said side scoring portions to said pockets.
